(19) United States
(12) Patent Application Publication
(10) Pub. No.: US 2003/0172718 A1
(43) Pub. Date: Sep. 18, 2003

(54) Gaseous sample injection apparatus for gas chromatography

(76) Inventors: Gang-Woong Lee, Seoul (KR); Mee-Hye Lee, Seoul (KR); Jin-Seok Han, Kyonggi-Do (KR); Jo-Chun Kim, Kwangjoo-Si (KR); Hee-Nam Song, Kyonggi-Do (KR)

Correspondence Address: COLEMAN SUDOL SAPONE, P.C., 714 Colorado Avenue, Bridgeport, CT, 06605-1601, US

(21) Appl. No.: 10/101,531

(22) Filed: Mar. 18, 2002

(51) Int. Cl. G01N 1/00

(52) U.S. Cl. 73/23.41

(57) ABSTRACT

The present Invention relates to a gaseous sample injection apparatus for a chromatography which is capable of implementing a low temperature adsorption, a sample loop filled with a fixed volume of gaseous sample transferred from the sample gas storing and injection unit, a carrier gas storing tank for carrying the sample gases from the loop to the sample gas analyzing apparatus (GC) and control valves for connecting or disconnecting the sample gas storing and injection unit and the sample loop and connecting or disconnecting the carrier gas storing tank and the loop.

### BACKGROUND OF THE INVENTION

1. Field of the Invention

This invention relates to a gaseous sample injecting apparatus for a gas chromatography, which is used for collecting and analyzing volatile organic compounds in the air, the water and the soil.

2. Description of the Background Art

In other to analyze volatile organic compounds, a gas chromatography (hereinafter called “GC”) is generally used. In addition, when collecting and injecting the volatile organic compound into the gas chromatography by a certain amount, two different methods are usually used among scientists.

One is called “cryogenic preconcentration method”, which is to liquefy and concentrate gaseous sample using liquid nitrogen or argon because of strong volatility of the gases, and then inject them into the GC.

The other is so called “thermal desorbing method along adsorbent absorption”. According to the method, sample gases are not liquefied but are just collected by a solid adsorption media, and then heat is applied to the adsorption media for thermal desorption and direct injection into a GC.

While cryogenic preconcentration method does produce excellent chromatographic results, it requires extremely costly liquefying apparatus and cryogens. In conventional thermal desorption method, poor chromatographic resolution due to large amount of elution volume for complete extraction of samples on adsorbent is the main disadvantage, and causes relatively low sensitivity. For this reason, most commercial thermal desorption instrument contains a re-focusing mechanism with small amount of adsorbent in electronically cooled tube to decrease the elution volume and to reduce time to desorb gaseous samples.

### SUMMARY OF THE INVENTION

Accordingly, it is an object of the present Invention to provide more improved gaseous sample injection apparatus for a gas chromatography, which overcomes the difficulties encountered in the conventional methods.

It is another object of the present Invention to provide a gaseous sample injection apparatus which is capable of implementing a desorption with a small volume of carrier gas to prevent a large sample gas dilution and to increase reproducibility in analytical results with instant (in a few hundred milliseconds) injection of samples to GC.

To achieve the above objects, we developed unique gaseous sample injection apparatus for a gas chromatography, which includes units of 1) a electronically cooled apparatus for lowering temperature to concentrate the gaseous samples in adsorbent, 2) heating mechanism for adsorbent in a tube for thermal desorption with desorbing gas, 3) temporary reservoir (heated syringe glass in withdrawal syringe pump) for thermally desorbed analytes from adsorbent tube, 4) a sample loop.

In our invention, the analytes on electronically cooled adsorbents is thermally desorbed and transferred to temporary reservoir, which is glass syringe in syringe pump. As withdrawing speed of syringe pump is equally matched with elution volume rate of desorbing gas into the adsorbent tube, the complete desorption can be achieved in a pressure close to ambient pressure with less than 5 ml of elution volume. However, in conventional termal desorber, high pressure desorption is required for direct capillary column injection. The low pressure desorption in our invention grants higher desorption efficiency in relatively low temperature and low elution volume, which insures the better analytical capability for thermally fragile compounds.

In the present invention, gaseous analytes is transfered to fixed volume (about 0.5 cc) sample loop in a 6-way valve by infusing syringe pump. After loading the loop with sample, it is switched to injection position and directly injected to GC column. The injection time is fast enough (less than a few hundred milli seconds) to produce uncompromised high resolution chromatography especially even in very small bore capillary columns. Exactly same injection of sample volume also yields excellent reproducibility in quantitative analysis.

### BRIEF DESCRIPTION OF THE DRAWINGS

The present Invention will become better understood with reference to the accompanying drawings which are given only by way of illustration and thus are not limitative of the present Invention, wherein;

FIGS. 1,2,3, and 4 are the views illustrating the structure and functions of a gaseous sample injection apparatus according to the present Invention; and

FIG. 1 is a view illustrating an operation state and flow path of concentrating samples on electronically cooled adsorbent (Sampling stage):

FIG. 2 is a view illustrating an operation state and flow path of sample desorption and transfer to glass syringe (Desorption stage):

FIG. 3 is a view illustrating an operation state and flow path of sample is supplied from syringe reservoir to the sample loop (Loop filling stage);

FIG. 4 is a view illustrating an operation state and flow path of which sample is stored in the sample loop is injected and carried to GC (Injection Stage).

### DETAILED DESCRIPTION OF THE PREFERRED EMBODIMENTS

The present Invention will be explained with reference to the accompanying drawings.

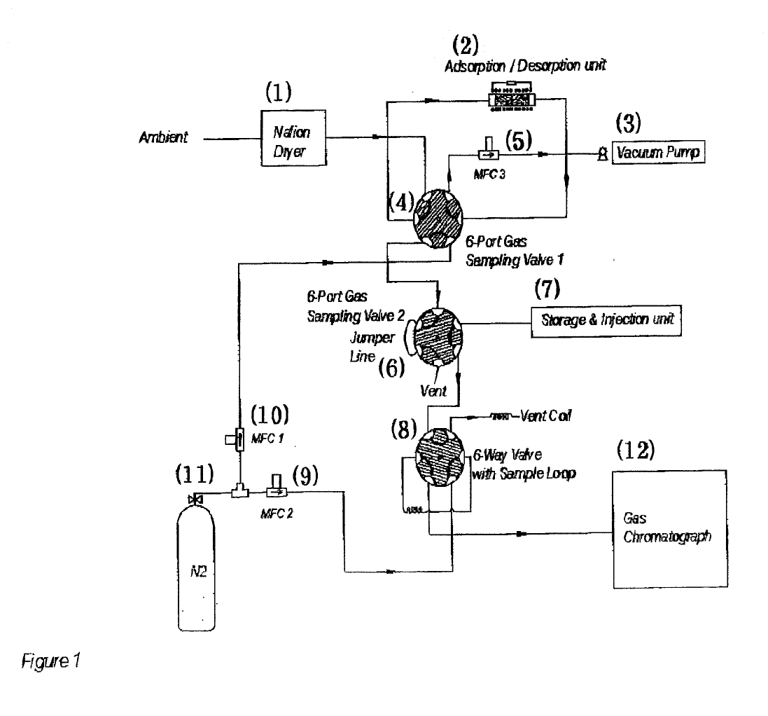

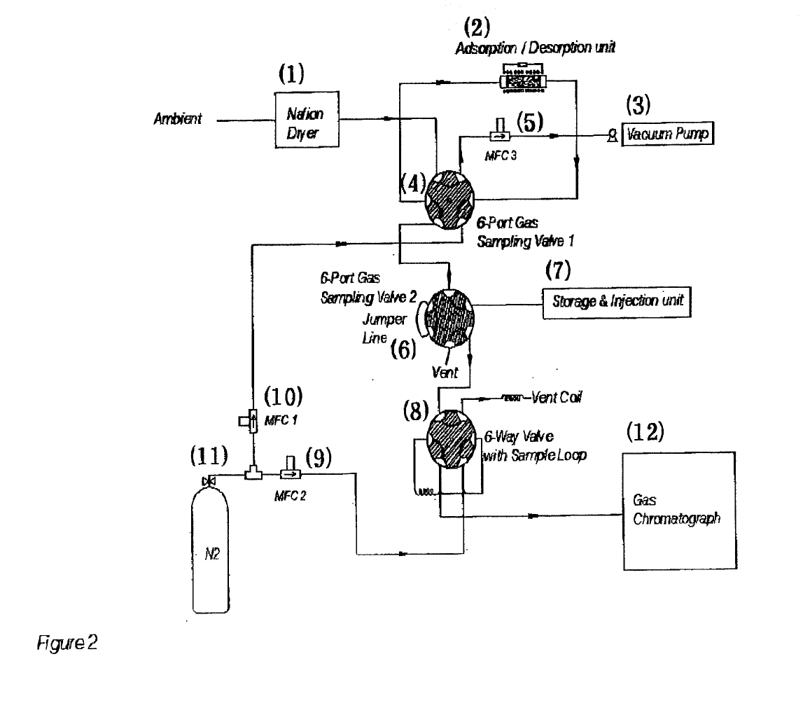

As shown in FIG. 1, gaseous sample injection apparatus according to the present Invention includes various components: Nafion dryer (1), adsorption/desorption unit (2) with low temperature cooler and heat coil, air sampling pump (3), three 6-port valves (4, 6, 8), storing and injection unit (7), carrier gas (11), three mass flow controllers (5,9,10), and a GC (12).

In sampling stage as shown in FIG. 1, the gaseous sample from sample inlet is carried by vacuum pump(3) and dried by passing through Nafion Dryer and collected on cooled sorbents (Tenax-A and Carbosieve) packed inside of tube made of glass or stainless steel in adsorption/desorption component (2). A cooling plate and a heating cable are wound on the outer surface of tube. This tube (2) can be cooled down to −30° C. One end of the adsorption/desorption unit (2) is connected with the Nafion drier (1) through the 6-port valve (4). Thereafter, the sample gases dried by the sample gas drier (1) passes through the adsorption/desorption tube (2) while it is maintained at very low temperature (−30° C.) and is selectively adsorbed and concentrated by the adsorbent. When sufficient amount of the sample gases are adsorbed to the low temperature adsorption tube (2), a DC power is supplied to the heating coil which surrounds the low temperature adsorption tube and heats the same at 200˜300°, so that the sample gas adsorbed to the adsorbent is thermally desorbed. A first 6-way valve (4) and a mass flow controller are installed for controlling the flow path and rate supplied to the adsorption/desorption tube (2). Therefore, it is possible to control the amount of the sampling adsorption according to the type and size of the sample.

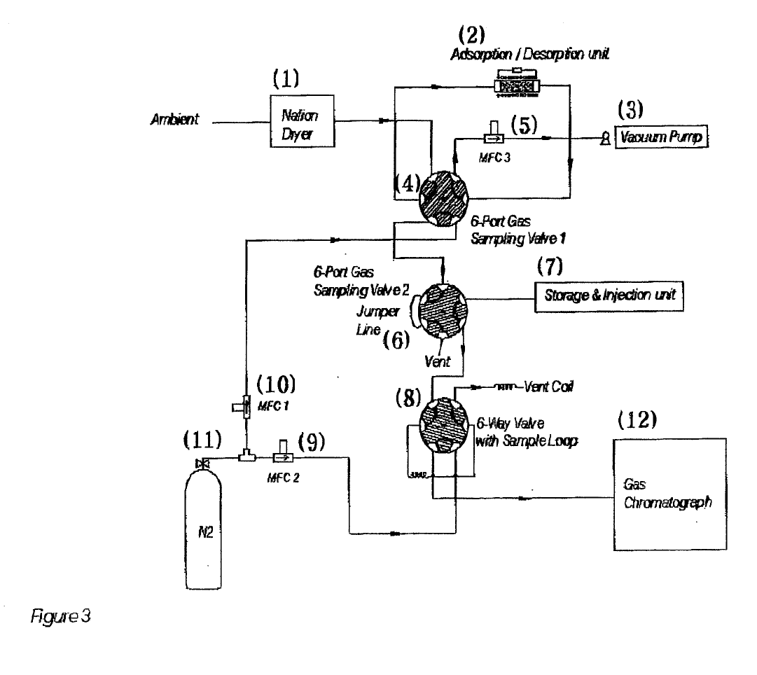

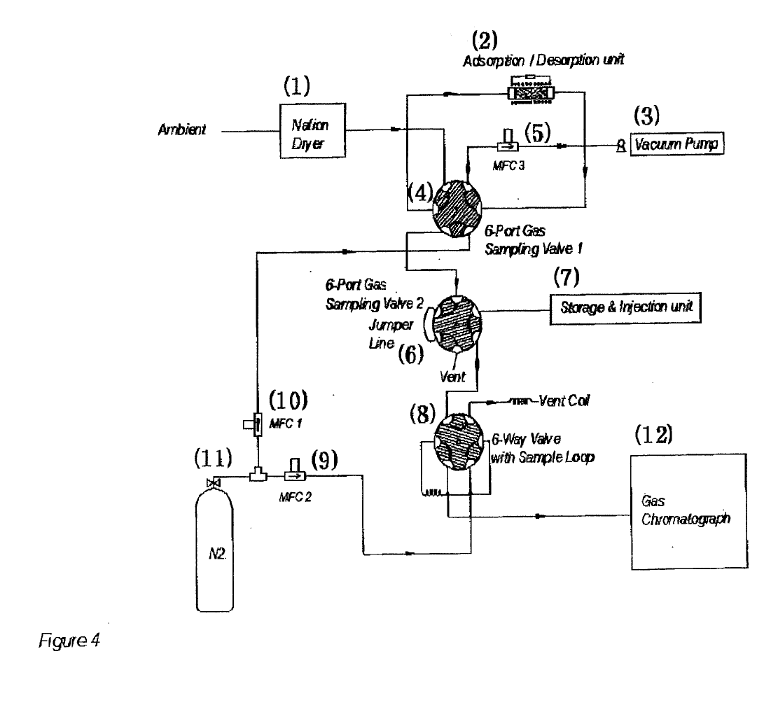

In desorption stage as shown in FIG. 2, The inlet and outlet of the low temperature adsorption tube 33 is connected with the inlet of sample storing and injection unit(7) and carrier gas(11) through a valve (4). At this time, the tube and its packed sorbents inside of adsoption/desorption unit (2) is heated to 200˜350°, which may be changed based on the types of the sample gas. When the tube unit (2) is heated, the sample gases therein is evaporated and is evacuated into the reservoir (usually glass syringe) in the sample storing and injection unit (7) by withdrawing syringe, passing through two valves(4 and 6). In this step, the mass flow controller (10) in the carrier line is opened for thereby supplying a same amount of the desorbing gas into the tube (2) and its path to storing and injection unit (7), so that it is possible to implement an efficient thermal desorption in sub-ambient pressure. At this time, 2-5 ml/min of the desorbing carrier gas flow rate for about 2 minute is generally recommended, making 4-10 ml of concentrated sample collected in the syringe. In addition, a heating is installed near the sample gas storing and supply unit(7). This heating prevents adsorption of less volatile compounds on surface of sample storing reservoir and implements a homogeneous mixing of sample.

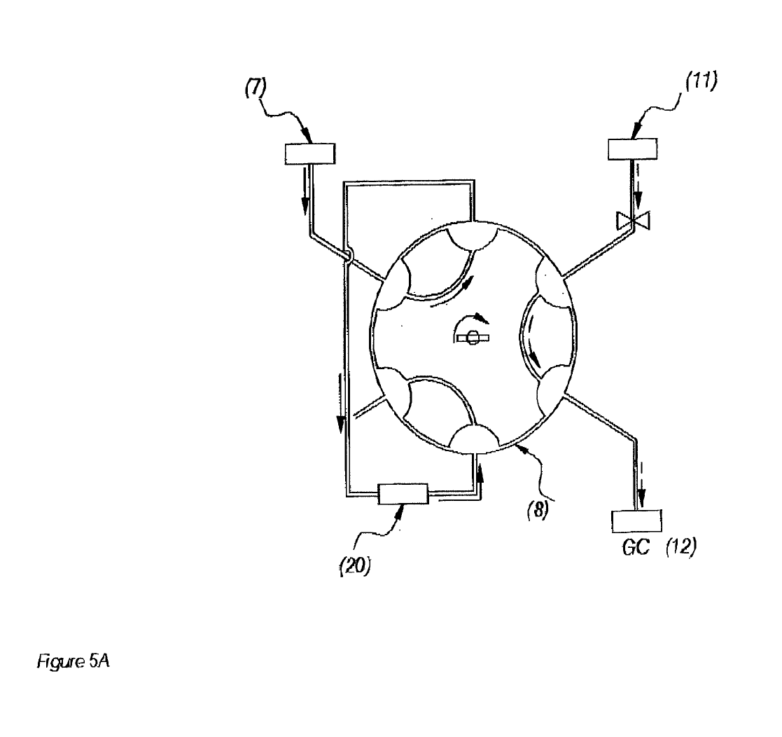

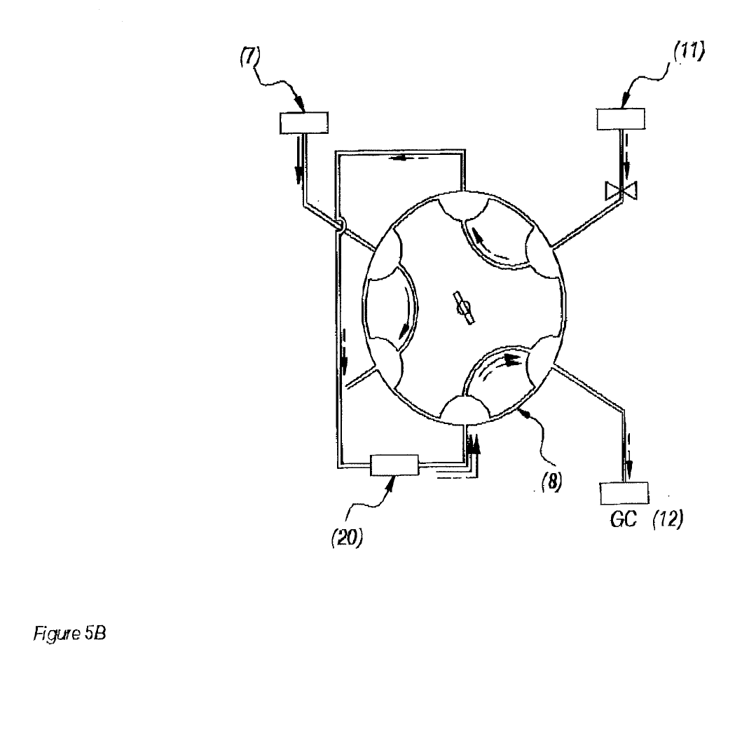

In loop filling stage as shown in FIG. 3, The sample storing and supply unit (7) is directly connected to a pre-configured 6-way valve (8) with a fixed volume (0.1-0.5 ml ) loop (20) and through a valve (6) (FIG. 3). When the valve positions were set for this configuration with a loop (20) in FIG. 5A and FIG. 3, the syringe pump starts its infusion motion and transfers the gaseous sample in the syringe of sample gas storing and supply unit to the sample loop (20) connected with 6-way valve (8). As the volume of gaseous sample transferred to loop is much larger than the sum of volumes of loop and the transfer line, the rest of samples is flushed out to vent coil. Since the sample loop and vent coil is formed of a very narrow bored tube, gaseous samples inside of loop is not easily contaminated with air outside even its one end of vent is open to ambient air.

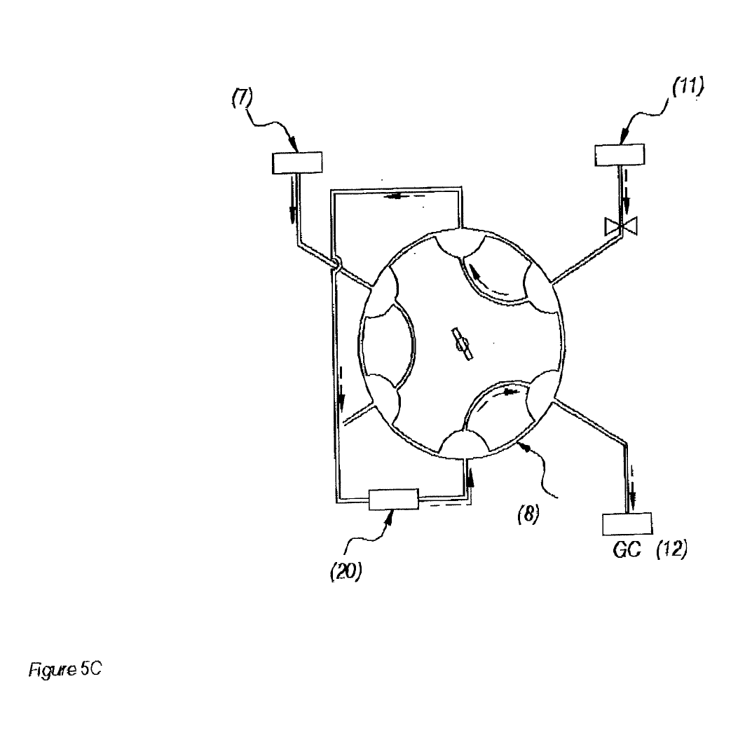

In sample injection stage as shown in FIG. 5B and FIG. 4, after the sample gas is filled into the loop (20), the valve (8) is switched to its position of which the carrier gas (11) transport the fixed volume of samples in the loop (20) into to the Gas Chromatograph (12). When the control valve (8) is switched to the position of FIG. 5B, the flow inlet of the loop (20) is closed, so that the sample gases are not flowed from the sample gas supply apparatus (7) into the loop (20). Instead, the inlet of the loop (20) is connected with the flow path to the carrier gas storing tank (11), and the outlet of the loop (20) is connected with the flow path to the GC(12), so that the carrier gas in the carrier gas tank (11) is flowed into the loop (20) in the direction of the dotted line arrow of FIG. 5B for thereby carrying the sample gases filled therein in the direction of the GC(12). Therefore, every time precisely same amount of the sample volume can be injected repeatedly and carried to the GC (12). Also, the injected volume (0.1-0.5 ml) from the loop is relatively small compared to the flow rate of carrier gas (larger than 3 ml/min) to the GC, the time required for complete injection to the GC column is so short that the peaks separation (resolution), especially for early elution species, in the GC is greatly improved. Usually, other thermal desorption techniques use complicated temperature desorption technique or secondly preconcentration with liquid coolant for fast injection to reduce the sample injection time and improve the peak separation. With our invention, we can achieve the greatly improved separation and reproducibility in gaseous sample analysis with GC.

As shown in FIGS. 5A through 2B, a 6-port rotary valve is generally used. In this case, a certain amount of sample gas is supplied from the sample storing and injection unit (7) to the sample loop (20). The operation that a certain amount of the sample gas in the loop (20) is carried to the GC will be explained below.

In a sample collecting step, adsorption/desorption unit (2) with low temperature cooler and air sampling pump (3) is installed in a pathway to which a certain amount of air is sampled for pre-fixed time, so that volatile organic compound s in it are selectively collected in the adsorption media in adsorption/desorption unit (2) maintained at low temperature. The adsorption/desorption unit (2) with low temperature cooler which collected the sample gases is installed in the apparatus according to the present Invention.

In a sample gas adsorption step, the dried sample gases with Nafion Dryer (1) are carried onto the low temperature adsorbent by a air vacuum pump (3) for a certain time. When the sampling is completed, the power is supplied to the heating coils wound on the outer portion of the adsorption tube for thereby heating to 200˜350°, so that the desorbed sample gases by the heat are carried into the sample gas storing and injection unit (7) by the carrier gas. The gaseous sample desorbed from the heated adsorbent is flowed to the direction of which the samples are carried into the sample storing and injection unit (7) which is the heated for 100° C. to implement the homogeneous mixing and prevent the condensation of water and other low volatile compounds. After a few minutes as the thermal desorption from adsorbent is completed, the position of valves (4 and 6) is switched to where the flow to sample storing and injection unit (7) is disconnected. Thereafter, valves (4 and 6) are configured for thereby blocking the flow of sample gases from adsorptin/desorptin unit (2) to the sample storing and injection unit(7), and the other valve (8) is switched to the position as shown in FIG. 5A. Thereafter, the sample storing and injection unit(7) is operated for thereby discharging the sample gases stored in sample storing and injection unit(7). The sample gases are flowed into the sample loop (20) through the control valve (8) in the direction of the arrow of FIG. 5A. When the sample gases are filled into the loop (20) by a certain amount, the control valve (8) is switched to the position of FIG. 5B.

When the control valve (8) is switched to the position of FIG. 5B, the flow inlet of the loop (20) is changed, so that the sample gases are not flowed from the sample storing and injection unit(7) into the loop (20). Instead, the inlet of the loop (20) is connected with the flow path to the carrier gas storing tank (11), and the outlet of the loop (20) is connected with the flow path to the GC, so that the carrier gas in the carrier gas storing tank (11) is flowed into the loop (20) in the direction of the dotted line arrow of FIG. 5B for thereby carrying the sample gases filled therein in the direction to GC. After sample desorbing, distributing and supplying, and analyzing operation are finished with respect to a kind of sample gases, the sample gases remaining in the apparatus should be completely cleaned to prevent the contamination from previous sample run. At this time, in a state that the control valve (8) is switched to the position of FIG. 5C, the carrier gas is flowed to the control valve (8). Therefore, the carrier gas is discharged through the control valve (8) and the loop (20) in the direction of the arrow indicated by the dotted line together with the remaining gas for thereby cleaning the apparatus.

As the injected volume (0.1-0.5 ml) from the loop (20) is relatively small compared to the flow rate of carrier gas (larger than 3 ml/min) to the GC, the short time required for complete injection to the GC column ensures the greatly improved peak separation to prevent a tailing phenomenon when analyzing the sample gases in the sample gas analyzing apparatus. And injection of precisely same volume from fixed volume loop (20) produce superior reproducibility in GC analysis. With our invention, we can significantly improve the degree of peak separation and reproducibility in gaseous sample analysis with GC. Also, in the present Invention, using a simply structured loop, it is possible to obtain a reliable analyzing result at a lower cost compared to other cryogenic pre-concentrator or complicated thermal desorption technique.

As the present Invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What to be claimed is:

1. a gaseous sample injection apparatus for a GC, comprising,
sample storing and injection unit for receiving the desorbed sample gases from the adsorption/desorption unit and carried by a carrier gas and moving the same to the next unit;
a first switching valve installed in a connection line for communicating the adsorption/desorption unit with the gaseous sample gas storing and injection unit for selectively opening and closing the flowing path of the connection line;
a sample loop for receiving a certain amount of sample gas supplied from the sample gas storing and injection unit;
a carrier gas storing tank for carrying the sample gases from the loop to the sample gas analyzing apparatus and storing and supplying the sample gas carrier gas; and
a control valve for connecting or disconnecting the sample gas storing and supply apparatus and the sample loop and connecting or disconnecting the carrier gas storing tank and the loop.
